(19) United States
(12) Patent Application Publication
(10) Pub. No.: US 2009/0139378 A1
(43) Pub. Date: Jun. 4, 2009

(54) Driver tool having adjustable structure

(75) Inventors: Wen Hung Chiang, Taichung Hsien (TW); Sheng Ming Chang, Taichung Hsien (TW)

Correspondence Address: CHARLES E. BAXLEY, ESQUIRE, 90 JOHN STREET, SUITE 309, NEW YORK, NY, 10038, US

(73) Assignee: Hsin Ying Enterprise Co., Ltd.

(21) Appl. No.: 11/998,585

(22) Filed: Nov. 30, 2007

(51) Int. Cl. B25B 23/00

(52) U.S. Cl. 81/438

(57) ABSTRACT

A driver tool includes a driver shank having a non-circular engaging hole for engaging with a tool member, a sleeve slidably engaged onto the driver shank and limited to slide relative to the driver shank, and an adjusting device for adjusting the sleeve relative to the driver shank to limit and to determine a sliding movement of the sleeve relative to the driver shank or to determine the outwardly extending of the tool member relative to the sleeve for allowing the tool member to suitably drive the fastener and for preventing the fastener from being deeply driven or engaged into the work pieces or for preventing the fastener from being damaged by the tool member.

### BACKGROUND OF THE INVENTION

1. Field of the Invention

The present invention relates to a driver tool, and more particularly to a driver tool including an adjustable structure for adjusting the outwardly extending status of the driver tool bits or driver tool members and for allowing the driver tool bits or driver tool members to suitably rotate or drive the fasteners and for preventing the fasteners from being deeply driven or engaged into the work pieces.

2. Description of the Prior Art

Typical screw drivers or driver tools comprise a driver shank attached to a power tool or extended from a handle member for engaging with and for driving various tool bits or tool members, and a magnetic member disposed or engaged in the driver shank for attracting or for engaging with the fasteners and for preventing the fasteners from being disengaged from the driver tool bits or driver tool members.

For example, U.S. Pat. No. 6,154,108 to Huang discloses one of the typical screw drivers or driver tools comprising a magnet attached to a driver tool bit with a body for attracting the fasteners to the driver tool bit and for preventing the fasteners from being disengaged from the driver tool bit.

However, normally, the magnet is solidly attached to the driver tool bit and may not be adjusted to different position or location relative to the driver tool bit such that the engagement of the fasteners into the work pieces may not be adjusted, and such that the fasteners may have a good chance to be deeply driven or engaged into the work pieces, and such that the fasteners may have a good chance to be over rotated or driven by the power tools and to be damaged by the power tools.

U.S. Pat. No. 6,511,268 to Vasudeva et al. discloses another typical tool device comprising a connector tube slidably attached to a tool mount, and a sleeve slidably attached to the connector tube, in which the connector tube includes a bit mount end for engaging with a drive tool bit or tool member.

However, the typical tool device have no place to attached the magnet, and the relative movement between the driver tool bits or tool members and the outer sleeve may not be adjusted such that the engagement of the fasteners into the work pieces also may not be adjusted, and such that the fasteners also may have a good chance to be deeply driven or engaged into the work pieces, and such that the fasteners also may have a good chance to be damaged by the power tools.

U.S. Pat. No. 6,931,967 to Chang discloses a further typical tool device comprising a connecting shaft, a detent slidably attached to the connecting shaft for engaging with a drive tool bit or tool member and for detachably anchoring or securing the drive tool bit or tool member to the connecting shaft, and a sliding sleeve slidably attached to the connecting shaft for actuating the detent to engage with the drive tool bit or tool member or for allowing the drive tool bit or tool member to be freely engaged into or disengaged from the connecting shaft.

However, the relative movement between the driver tool bits or tool members and the outer sleeve may not be adjusted such that the engagement of the fasteners into the work pieces also may not be adjusted, and such that the fasteners also may have a good chance to be deeply driven or engaged into the work pieces, and such that the fasteners also may have a good chance to be damaged by the power tools.

The present invention has arisen to mitigate and/or obviate the afore-described disadvantages of the conventional screw drivers or driver tools.

### SUMMARY OF THE INVENTION

The primary objective of the present invention is to provide a driver tool including an adjustable structure for adjusting the outwardly extending status of the driver tool bits or driver tool members and for allowing the driver tool bits or driver tool members to suitably rotate or drive the fasteners and for preventing the fasteners from being deeply driven or engaged into the work pieces.

In accordance with one aspect of the invention, there is provided a driver tool comprising a driver shank including a first end portion and a second end portion, and including a non-circular engaging hole formed in the first end portion thereof for engaging with a tool member and for allowing the tool member to be rotated and driven by the driver shank, a sleeve slidably engaged onto the driver shank and limited to slide relative to the driver shank and extendible out of the first end portion of the driver shank, and an adjusting device for adjusting the sleeve relative to the driver shank to limit and to determine a sliding movement of the sleeve relative to the driver shank for allowing the driver tool bits or driver tool members to suitably rotate or drive the fasteners and for preventing the fasteners from being deeply driven or engaged into the work pieces or for preventing the fastener from being damaged by the tool member.

The driver shank includes an outer thread formed thereon, and the adjusting device includes a barrel having an inner thread formed therein for engaging with the outer thread of the driver shank and for allowing the barrel to be longitudinally moved and adjusted relative to the driver shank.

The inner thread of the barrel is formed in a first end portion of the barrel, and the first end portion of the barrel is contactable and engageable with the sleeve for limiting the sleeve to slide relative to the tubular member.

The adjusting device includes an anchoring device for anchoring the barrel to the driver shank to prevent the barrel from being rotated relative to the driver shank and to prevent the barrel from being longitudinally moved or adjusted relative to the driver shank.

The anchoring device includes a tubular member having a non-circular bore formed therein for slidably engaging with the driver shank and for preventing the tubular member from being rotated relative to the driver shank, and the tubular member is engageable with the barrel for preventing the barrel from being rotated relative to the driver shank.

The tubular member includes a peripheral rib extended radiallly and outwardly therefrom for selectively engaging with the barrel and for limiting the barrel to slide relative to the tubular member.

The tubular member includes an outer peripheral gear formed thereon, and the barrel includes an inner peripheral gear formed therein for selectively engaging with the outer peripheral gear of the tubular member and for anchoring the barrel to the tubular member and for preventing the barrel from being rotated relative to the tubular member and the driver shank.

The anchoring device includes a retaining ring disposed between the tubular member and the barrel for determining an engagement of the inner peripheral gear of the barrel with the outer peripheral gear of the tubular member.

The retaining ring is disposed on an outer peripheral portion of the tubular member, and the barrel includes a first ratchet peripheral groove and a second ratchet peripheral groove formed therein for engaging with the retaining ring and for limiting the barrel to slide relative to the tubular member.

The inner peripheral gear of the barrel is selectively engaged with the outer peripheral gear of the tubular member when the retaining ring is engaged with the first ratchet peripheral groove of the barrel, the inner peripheral gear of the barrel is selectively disengaged from the outer peripheral gear of the tubular member when the retaining ring is engaged with the second ratchet peripheral groove of the barrel.

The driver shank includes a peripheral depression formed in an outer peripheral portion thereof, and the sleeve includes a retaining ring slidably engaged with the peripheral depression of the driver shank for guiding or limiting the sleeve to slide relative to the driver shank.

The sleeve includes a magnetic member disposed in the sleeve for attracting and retaining a fastener to the tool member, and the magnetic member includes a bore formed therein for receiving the tool member. The sleeve includes a magnetic insulating member disposed beside the magnetic member and engaged with the magnetic member.

The driver shank includes a magnetic member disposed in the engaging hole of the driver shank for attracting the tool member to the driver shank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a driver tool in accordance with the present invention;

FIG. 2 is a perspective view of the driver tool, in which a portion of the driver tool has been cut off for showing the inner structure of the driver tool;

FIG. 3 is a cross sectional view of the driver tool taken along lines 3-3 of FIG. 2;

FIG. 4 is a cross sectional view similar to FIG. 3 illustrating the operation of the driver tool; and

FIG. 5 is a further cross sectional view similar to FIGS. 3 and 4 illustrating the operation of the driver tool.

### DETAILED DESCRIPTION OF THE PREFERRED EMBODIMENT

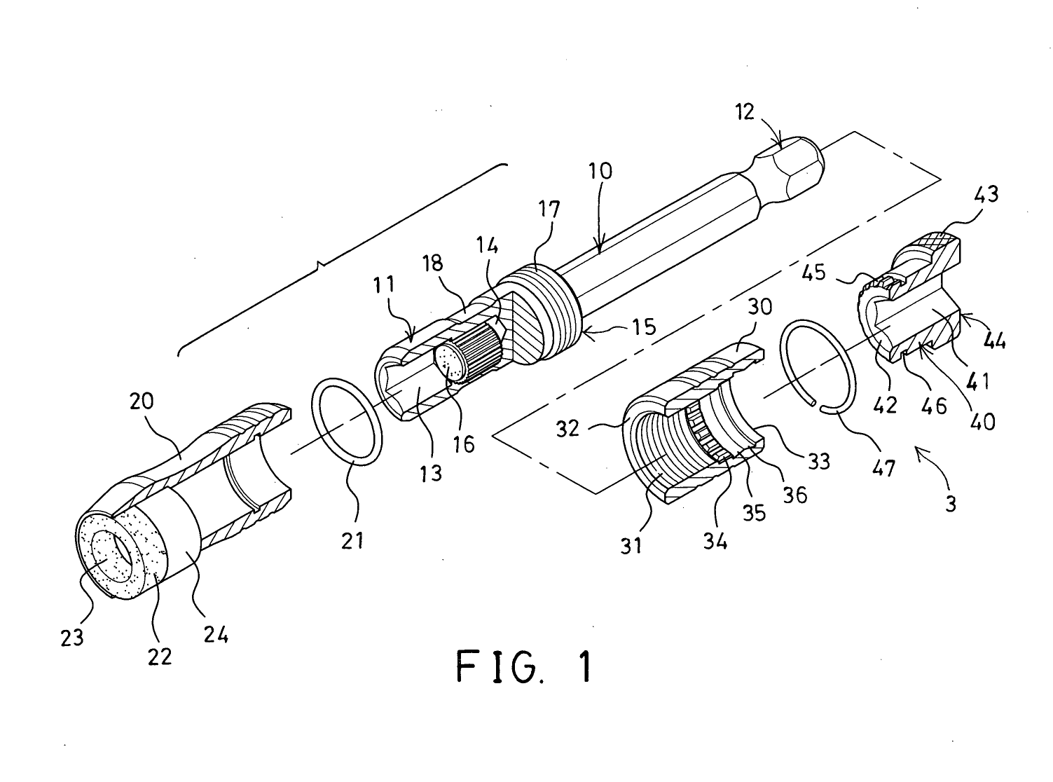

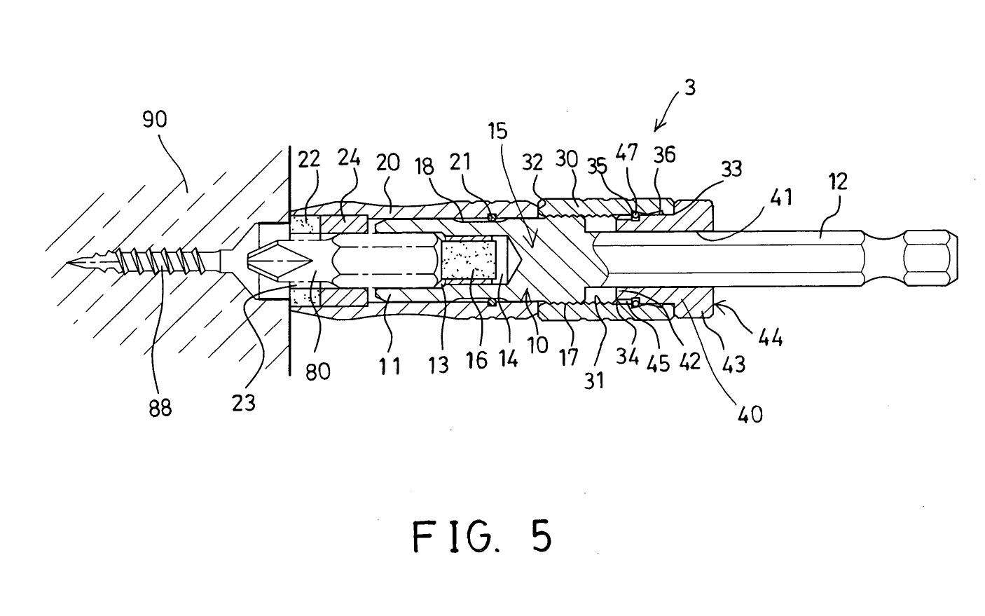

Referring to the drawings, and initially to FIGS. 1-3, a driver tool in accordance with the present invention comprises a driver shank 10 including two end portions 11, 12, in which one of the two end portions 12 includes a non-circular cross section for being coupled to a driving tool facility, such as a handle member of a screw driver, a power driving tool, or other driving tools, and for allowing the driver shank 10 to be rotated or driven by the driving tools. The driver shank 10 includes an engaging hole 13 formed in the other end portion 11 thereof and having a non-circular cross section for engaging with various tool bits or tool members 80 (FIGS. 4, 5) and for allowing the tool bits or tool members 80 to be rotated or driven by the driver shank 10.

The driver shank 10 further includes a cavity or blind hole 14 formed in the middle portion 15 thereof and communicating with the engaging hole 13 of the driver shank 10 for receiving or engaging with a magnetic member 16 which may be provided or used for engaging with the tool bits or tool members 80 and for stably or solidly retaining the tool bits or tool members 80 to the driver shank 10 and for allowing the tool bits or tool members 80 to be stably or solidly rotated or driven by the driver shank 10, and includes an outer thread 17 formed or provided on the middle portion 15 thereof, and includes a peripheral depression 18 formed in the outer peripheral portion thereof and located at or in the other end portion 11 of the driver shank 10.

A sleeve 20 is provided and slidably engaged with or onto the other end portion 11 of the driver shank 10, and extendible out of the other end portion 11 of the driver shank 10, and includes a clamping or retaining ring 21 attached or secured in the inner peripheral portion thereof and slidably engaged with the peripheral depression 18 of the driver shank 10 for limiting the sleeve 20 to slide relative to the driver shank 10 and for preventing the sleeve 20 from being disengaged from the driver shank 10, and includes another magnetic member 22 disposed or engaged in the other end portion thereof, and the magnetic member 22 includes a bore 23 formed therein for receiving or engaging with either of the tool bits or tool members 80 and for selectively attracting or stably or solidly retaining the fastener 88 to the tool bits or tool members 80 (FIGS. 4, 5).

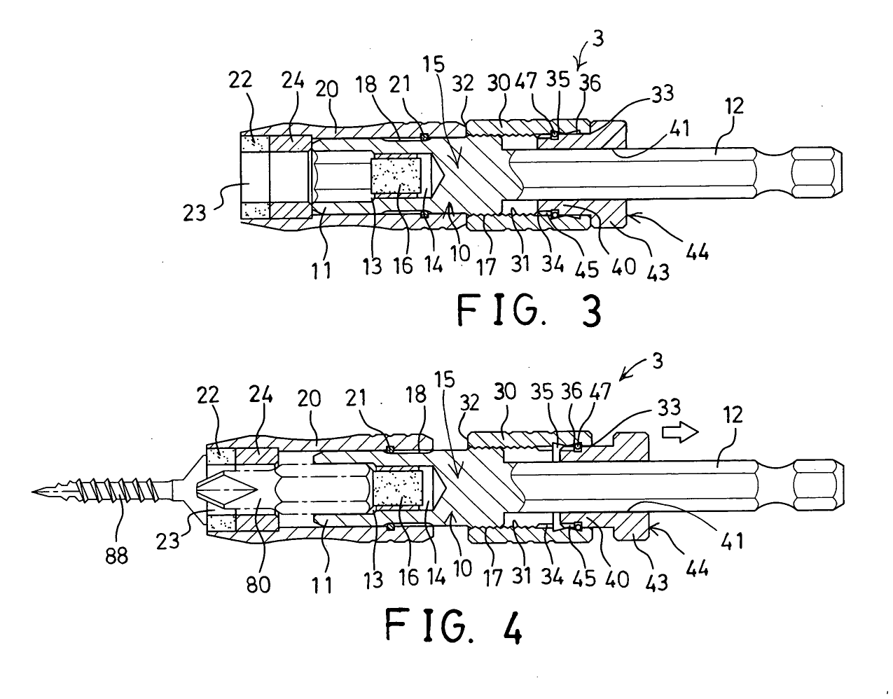

In operation, as shown in FIGS. 3-5, the sleeve 20 may slide or move relative to the driver shank 10 and the tool member 80, and may be limited to slide relative to the driver shank 10 with the sliding engagement between the retaining ring 21 and the peripheral depression 18 of the driver shank 10 for allowing the tool member 80 to slide or to extend out of the bore 23 of the magnetic member 22 and to move relative to the magnetic member 22, the sliding engagement between the retaining ring 21 and the peripheral depression 18 of the driver shank 10 may also be used to determine the outwardly extending of the tool member 80 relative to the magnetic member 22 for allowing the driver tool member 80 to suitably rotate or drive the fastener 88 and for preventing the fastener 88 from being deeply driven or engaged into the work pieces 90 (FIG. 5).

For example, as shown in FIG. 4, when the sleeve 20 is moved forwardly relative to the driver shank 10 toward the frontmost position, the tool member 80 is allowed to slightly extend out through the bore 23 of the magnetic member 22 for a small distance that is good enough for the driver tool member 80 to engage with the fastener 88 and to rotate or drive the fastener 88. When the sleeve 20 is moved rearwardly relative to the driver shank 10, for example, as shown in FIG. 5, when the sleeve 20 is engage with the work piece 90, the tool member 80 is allowed to extend out through the bore 23 of the magnetic member 22 for an increased or greater distance in order to suitably or deeply drive the fastener 88 into the work piece 90.

It is preferable that the sleeve 20 further includes a ring or annular magnetic separating or insulating member 24 disposed or engaged therein and disposed between the magnetic member 22 and the retaining ring 21, and preferably contacted or engaged with the magnetic member 22, and made of non-conductive or magnetic insulating materials for concentrating the magnetic member to attract the fastener 88 and for preventing the magnetic member 22 from attracting the other end portion 11 of the driver shank 10, and for allowing the sleeve 20 to be freely moved or slid along and relative to the driver shank 10. An adjusting means or device 3 may further be provided and attached to the driver shank 10 for engaging with the sleeve 20 and for limiting the sleeve 20 to slide relative to the driver shank 10 and for determining the sliding movement of the sleeve 20 relative to the driver shank 10.

The adjusting means or device 3 includes a barrel 30 slidably engaged onto the driver shank 10 and having an inner thread 31 formed or provided in one end portion 32 thereof for threading or engaging with the outer thread 17 of the driver shank 10 and for allowing the barrel 30 to be longitudinally or axially moved and micro-adjusted relative to the driver shank 10 in order to determine the sliding movement of the sleeve 20 relative to the driver shank 10, and the one end portion 32 of the barrel 30 is contactable and engageable with the sleeve 20 for forming or acting as an adjusting means or device for adjusting the sleeve 20 relative to the driver shank 10. The barrel 30 includes another end portion 33 having a number of teeth or an inner peripheral gear 34 and two ratchet peripheral grooves 35, 36 formed or provided in the other end portion 33, in which the ratchet peripheral grooves 35, 36 are inclined toward different or opposite directions and preferably disposed between the other end portion 33 and the inner peripheral gear 34 of the barrel 30.

The adjusting means or device 3 further includes a tubular member 40 having a non-circular bore 41 formed therein for slidably engaging with or onto the driver shank 10 and for preventing the tubular member 40 from being rotated relative to the driver shank 10, and includes a first or inner end 42 for engaging into the other end portion 33 of the barrel 30, and includes a peripheral rib 43 extended radiallly and outwardly from the second or outer end 44 thereof for engaging with the barrel 30 and for limiting the barrel 30 to slide relative to the tubular member 40, and includes a number of teeth or an outer peripheral gear 45 formed or provided thereon and preferably located closer to the first or inner end 42 and distal to the second or outer end 44 thereof for selectively engaging with the inner peripheral gear 34 of the barrel 30 and for preventing the barrel 30 from being rotated relative to the tubular member 40 and the driver shank 10.

The tubular member 40 further includes a peripheral slot 46 formed in the first or inner end 42 thereof for engaging with a retaining ring 47 which is engageable with the either of the ratchet peripheral grooves 35, 36 of the barrel 30 for determining the sliding movement or engagement of the inner peripheral gear 34 of the barrel 30 with the outer peripheral gear 45 of the tubular member 40. For example, as shown in FIG. 4, when the retaining ring 47 is engaged with one of the ratchet peripheral grooves 36 of the barrel 30, the outer peripheral gear 45 of the tubular member 40 is disengaged from the inner peripheral gear 34 of the barrel 30, for allowing the barrel 30 to be longitudinally or axially moved and micro-adjusted relative to the driver shank 10 in order to determine the sliding movement of the sleeve 20 relative to the driver shank 10.

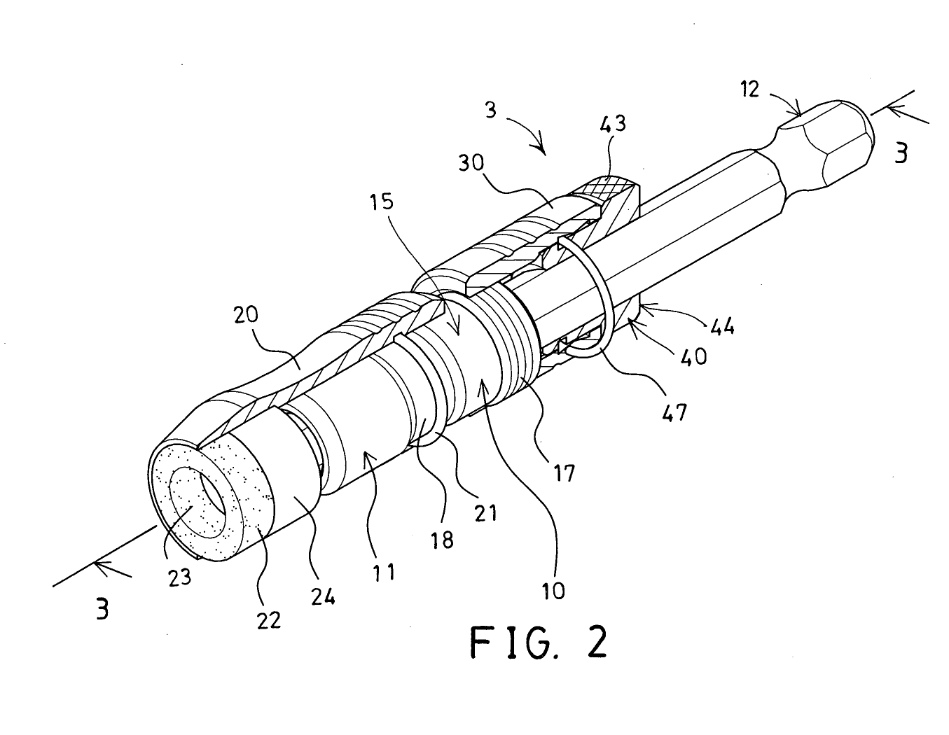

As shown in FIGS. 2-3 and 5, when the retaining ring 47 is engaged with the other ratchet peripheral groove 35 of the barrel 30, the outer peripheral gear 45 of the tubular member 40 is meshed or engaged with the inner peripheral gear 34 of the barrel 30 such that the barrel 30 may be prevented from rotating relative to the tubular member 40 and the driver shank 10 and such that the barrel 30 may no longer be axially moved and micro-adjusted relative to the driver shank 10. The tubular member 40 may thus be used and formed or acted as a locking or anchoring means or device for locking or anchoring the barrel 30 to the driver shank 10 and for preventing the barrel 30 from being rotated relative to the driver shank 10 and from being longitudinally moved or micro-adjusted relative to the driver shank 10.

Accordingly, the driver tool in accordance with the present invention including an adjustable structure for adjusting the outwardly extending status of the driver tool bits or driver tool members and for allowing the driver tool bits or driver tool members to suitably rotate or drive the fasteners and for preventing the fasteners from being deeply driven or engaged into the work pieces.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A driver tool comprising:
a driver shank including a first end portion and a second end portion, and including a non-circular engaging hole formed in said first end portion thereof for engaging with a tool member and for allowing the tool member to be rotated and driven by said driver shank, and including an outer thread formed on said driver shank,
a sleeve slidably engaged onto said driver shank and limited to slide relative to said driver shank and extendible out of said first end portion of said driver shank,
a barrel including an inner thread formed therein for engaging with said outer thread of said driver shank and for allowing said barrel to be longitudinally moved and adjusted relative to said driver shank, and said barrel including a first end portion contactable and engageable with said sleeve for limiting said sleeve to slide relative to said driver shank and for adjusting a sliding movement of said sleeve relative to said driver shank.

2-4. (canceled)

5. The driver tool as claimed in claim 1, wherein a tubular member includes a non-circular bore formed therein for slidably engaging with said driver shank and for preventing said tubular member from being rotated relative to said driver shank, and said tubular member is engageable with said barrel for anchoring said barrel to said driver shank and for preventing said barrel from being rotated and adjusted relative to said driver shank.

6. The driver tool as claimed in claim 5, wherein said tubular member includes a peripheral rib extended radially and outwardly therefrom for selectively engaging with said barrel and for limiting said barrel to slide relative to said tubular member.

7. The driver tool as claimed in claim 5, wherein said tubular member includes an outer peripheral gear formed thereon, and said barrel includes an inner peripheral gear formed therein for selectively engaging with said outer peripheral gear of said tubular member and for preventing said barrel from being rotated relative to said tubular member and said driver shank.

8. The driver tool as claimed in claim 7, wherein a retaining ring is disposed between said tubular member and said barrel for determining an engagement of said inner peripheral gear of said barrel with said outer peripheral gear of said tubular member.

9. The driver tool as claimed in claim 8, wherein said retaining ring is disposed on an outer peripheral portion of said tubular member, and said barrel includes a first ratchet peripheral groove and a second ratchet peripheral groove formed therein for engaging with said retaining ring and for limiting said barrel to slide relative to said tubular member.

10. The driver tool as claimed in claim 9, wherein said inner peripheral gear of said barrel is engaged with said outer peripheral gear of said tubular member when said retaining ring is engaged with said first ratchet peripheral groove of said barrel, said inner peripheral gear of said barrel is disengaged from said outer peripheral gear of said tubular member when said retaining ring is engaged with said second ratchet peripheral groove of said barrel.

11. The driver tool as claimed in claim 1, wherein said driver shank includes a peripheral depression formed in an outer peripheral portion thereof, and said sleeve includes a retaining ring slidably engaged with said peripheral depression of said driver shank for limiting said sleeve to slide relative to said driver shank.

12. The driver tool as claimed in claim 1, wherein said sleeve includes a magnetic member disposed in said sleeve for attracting and retaining a fastener to the tool member, and said magnetic member includes a bore formed therein for receiving the tool member.

13. The driver tool as claimed in claim 12, wherein said sleeve includes a magnetic insulating member disposed beside said magnetic member and engaged with said magnetic member.

14. The driver tool as claimed in claim 1, wherein said driver shank includes a magnetic member disposed in said engaging hole of said driver shank for attracting the tool member to said driver shank.
